(19) United States
(12) Patent Application Publication
(10) Pub. No.: US 2012/0103374 A1
(43) Pub. Date: May 3, 2012

(54) WASHING DEVICE AND BRAKE MECHANISM THEREOF

(76) Inventor: Hsin-Jen LI, Taichung City (TW)

(21) Appl. No.: 12/917,501

(22) Filed: Nov. 2, 2010

(51) Int. Cl. B08B 3/00; F16D 65/16

(52) U.S. Cl. 134/157; 188/67

(57) ABSTRACT

A washing device and brake mechanism thereof includes a casing and a bucket received in the casing. The bucket has a plurality of through holes and orifices defined therein. A brake mechanism is connected with the casing and includes a base mounted on the casing. The base has a receiving space defined therein. A spindle is pivotally connected with the bucket for driving the bucket to rotate. A seat is received in the receiving space and two support portions oppositely formed thereon. A pedal is pivotally connected with the seat and located between the two support portions for driving the spindle to rotate. The pedal has a braking pad disposed thereon for selectively abutting against the spindle. When the braking pad is driven by the pedal, the spindle is abutted against by the braking pad and stops rotating.

### BACKGROUND OF THE INVENTION

1. Field of the Invention

The present invention relates to a device and brake mechanism thereof, and more particularly to a washing device and brake mechanism thereof, wherein the brake mechanism has a braking pad for quickly stopping the operation of the washing device.

2. Description of Related Art

A conventional washing device includes a casing and a washing bucket mounted in the casing. A wringing rack is received in the washing bucket. A transmitting mechanism is mounted in a bottom of the casing for rotatably driving the wringing rack. When operating, a mop is washed in the washing bucket and received in the wringing rack. After releasing the filthy water in the washing bucket, the transmitting mechanism is switched to drive the wringing rack for wringing the mop.

However, the conventional washing device lacks a design for receiving the clothes and stirring the clothes. Therefore, the conventional washing device is not suitable for washing the clothes.

Another conventional washing device includes a bucket, a spoiler received in the bucket and a dehydration tank received in the bucket. Two driving mechanisms are mounted on a bottom of the bucket for corresponding to the spoiler and the dehydration tank. A pouring mouth and a grip are disposed on a top of the bucket. When operating, the clothes are received in the bucket, which is filled with water. The spoiler is switched on for washing the clothes. The washed clothes are putted into the dehydration tank for dehydrating the water.

However, based on energy consumption, the conventional washing device is not able to provide a better centrifugal effect.

The present invention has arisen to mitigate and/or obviate the disadvantages of the conventional washing device.

### SUMMARY OF THE INVENTION

The main objective of the present invention is to provide an improved washing device and brake mechanism thereof for generating a relatively greater centrifugal force in a direction or in an opposite direction.

To achieve the objective, the washing device and brake mechanism thereof in accordance with the present invention includes a casing, a bucket movably received in the casing, and a brake mechanism connected with the casing.

The casing has a cover openably mounted thereon for selectively sealing the casing. The cover has an inlet defined therein, such that water flows into the casing via the inlet. The casing has an opening defined in a bottom thereof and extending therethrough. A releasing valve is received in the casing and connected with the cover. The releasing valve selectively seals the opening for controlling the drainage of the casing.

The bucket has a plurality of through holes defined in a lateral thereof and extending therethrough for allowing water passing through the through holes. The bucket has a plurality of orifices defined in a bottom thereof and extending therethrough for allowing water passing through the orifices. The bucket has a plurality of turbulent surfaces inclinedly formed on the bottom thereof and respectively disposed adjacent to the orifices for increasing a swirling power when the bucket is rotated. A washing plate is rotatably received in the bucket. The washing plate has a plurality of grooves radially defined therein and extending therethrough for allowing water passing through the grooves.

The brake mechanism comprises a base mounted on the bottom of the casing. The base has a receiving space defined in a bottom thereof. A skid-proof mat is mounted on the bottom of the base. The base has a storage space defined in a top thereof and located adjacent to the receiving space, such that water flows from the casing via the opening and is stored in the storage space. The base has an outlet defined in the storage space for draining water from the storage space.

The brake mechanism comprises a spindle, a gear set, a reducer, a seat and a pedal received in the receiving space of the base. The spindle is partially received in the receiving space. The spindle is pivotally connected with the bucket and coaxially sleeved on the washing plate for simultaneously driving the bucket to rotate. The reducer is movably and coaxially mounted on the spindle for decreasing a rotating speed and increasing a driving power. The gear set is connected with the spindle for simultaneously driving the spindle. The seat has two support portions oppositely formed thereon and extending upwardly therefrom. A rod is pivotally connected with the two support portions of the seat.

The pedal is pivotally connected with the rod and located between the two support portions of the seat. The pedal moveably engages with the gear set, such that the spindle is simultaneously rotated via the gear set by a movement of the pedal. The pedal has a braking pad disposed on one side thereof and corresponding to the spindle. The braking pad has a cutout defined therein. The cutout has a friction section formed on an interior surface thereof for selectively rubbing against the spindle. An elastomer is pivotally connected with the rod and located adjacent to the pedal for providing a resilient force to the pedal.

When the pedal is operated, the spindle is pivotally rotated by the movement of the pedal. The bucket is rotated relative to the casing by a rotation of the spindle for providing a centrifugal force to wash clothing items. When the braking pad is simultaneously moved with the pedal, the friction section of the braking pad restricts and abuts against the spindle to stop the spindle rotating.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a washing device and brake mechanism thereof in accordance with the present invention;

FIG. 2 is an enlarged perspective view of a pedal of the washing device and brake mechanism thereof in accordance with the present invention;

FIG. 3 is a cross-sectional assembled view of the washing device and brake mechanism thereof in accordance with the present invention;

FIGS. 4-6 are partial cross-sectional operational views of the washing device and brake mechanism thereof in accordance with the present invention;

FIG. 7 is a top plan view of a bucket and a washing plate in FIG. 5 of the washing device and brake mechanism thereof in accordance with the present invention; and

FIG. 8 is a partial top plan view of the bucket and the washing plate in FIG. 6 of the washing device and brake mechanism thereof in accordance with the present invention.

### DETAILED DESCRIPTION OF THE INVENTION

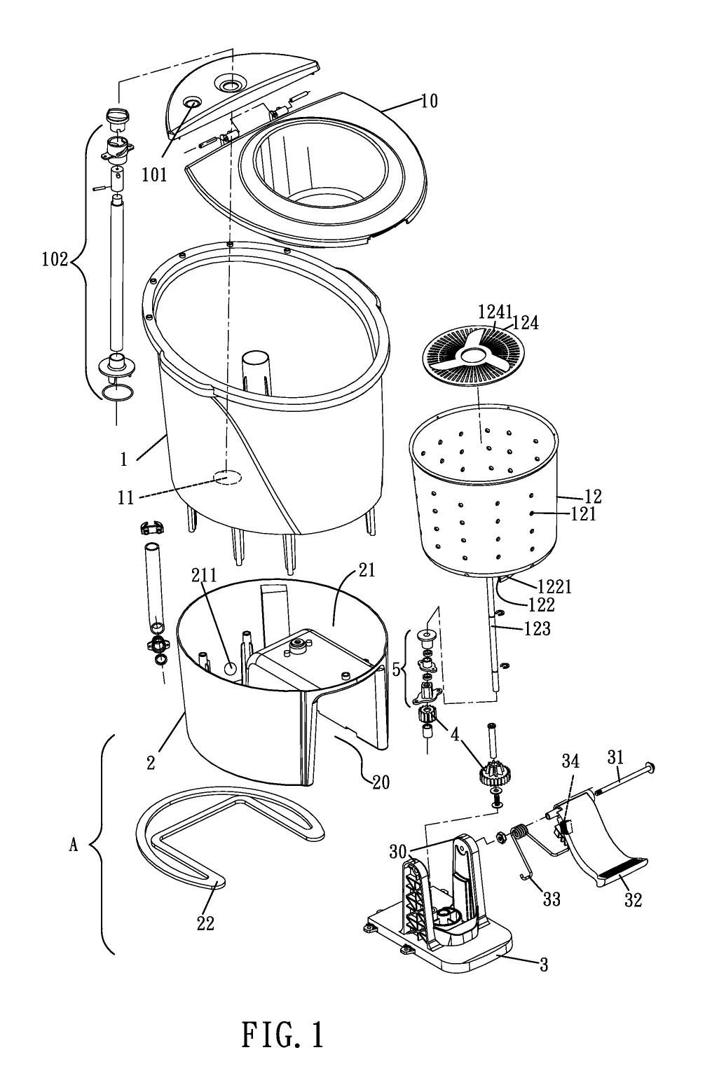

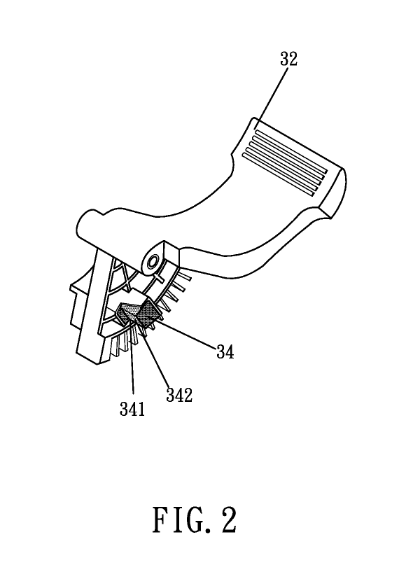

Referring to the drawings and initially to FIGS. 1-3, a washing device and brake mechanism thereof in accordance with the present invention is provided with a washing device which has a brake mechanism (A) mounted thereon for quickly driving/stopping an operation of the washing device. The washing device comprises a casing (1), a bucket (12) movably received in the casing (1), and the brake mechanism (A) operatively connected with a bottom of the casing (1).

The casing (1) has a cover (10) openably and pivotally mounted on a top thereof for selectively sealing the casing (1). The cover (10) has an inlet (101) defined therein, such that water is able to be poured into the casing (1) via the inlet (101). The casing (1) has an opening (11) defined in the bottom thereof and extending therethrough for draining water from the casing (1). A releasing valve (102) is axially received in the casing (1) and connected with the cover (10). The releasing valve (102) is operated to selectively seal or unseal the opening (11) for controlling the drainage of the casing (1).

The bucket (12) is coaxially mounted in the casing (1) for receiving dirty clothing items (not shown). The bucket (12) has a plurality of through holes (121) defined in a lateral thereof and extending therethrough for allowing water passing through the through holes (121). The bucket (12) has a plurality of orifices (122) defined in a bottom thereof and extending therethrough for allowing water passing through the orifices (122). The bucket (12) has a plurality of turbulent surfaces (1221) inclinedly formed on the bottom thereof and respectively disposed adjacent to the orifices (122) for increasing a swirling power when the bucket (12) is rotated. A washing plate (124) is rotatably received in the bucket (12). The washing plate (124) has a plurality of grooves (1241) radially defined therein and extending therethrough for allowing water passing through the grooves (1241).

The brake mechanism (A) comprises a base (2) mounted on the bottom of the casing (1). The base (2) has a receiving space (20) defined in a bottom thereof. A skid-proof mat (22) is mounted on the bottom of the base (2) for preventing the washing device from skidding during operation. The base (2) has a storage space (21) defined in a top thereof and located adjacent to the receiving space (20). The storage space (21) communicates with the casing (1) via the opening (11), such that water flows from the casing (1) via the opening (11) and is stored in the storage space (21). The base (2) has an outlet (211) defined in the storage space (21) for draining water from the storage space (21).

The brake mechanism (A) comprises a spindle (123), a gear set (4), a reducer (5), a seat (3) and a pedal (32) received in the receiving space (20) of the base (2). The spindle (123) is partially received in the receiving space (20) and passes through the bottom of the casing (1). The spindle (123) is pivotally connected with the bottom of the bucket (12) and coaxially sleeved on a center of the washing plate (124) for simultaneously driving the bucket (12) to rotate relative to the casing (1). The reducer (5) is disposed the top of the base (2). The reducer (5) is movably and coaxially mounted on the spindle (123) for decreasing a rotating speed of the spindle (123) and increasing a driving power. The gear set (4) is connected with the spindle (123) for simultaneously driving the spindle (123). The seat (3) has two support portions (30) oppositely formed on a top thereof and extending upwardly therefrom. A rod (31) has two ends pivotally and respectively connected with the two support portions (30) of the seat (3).

The pedal (32) has one end pivotally connected with the rod (31) and located between the two support portions (30) of the seat (3). Another end of the pedal (32) is adapted to be treaded by a user for driving the pedal (32) to pivotally rotate about the rod (31). The pedal (32) movably engages with the gear set (4) to drive the gear set (4), such that the spindle (123) is simultaneously rotated via the gear set (4) by a movement of the pedal (32). The pedal (32) has a braking pad (34) disposed on one side thereof and corresponding to the spindle (123). The braking pad (34) has a cutout (341) defined therein for selectively engaging with the spindle (123). The cutout (341) has a friction section (342) formed on an interior surface thereof for selectively rubbing against the spindle (123). As the friction section (342) rubs against the spindle (123), a friction force is generated between the friction section (342) and the spindle (123) for stopping the spindle (123) from rotating. An elastomer (33) is pivotally connected with the rod (31) and located between the two support portions (30) of the seat (3). The elastomer (33) is a twist spring which has one end abutting against the pedal (32) for providing a resilient force to the pedal (32).

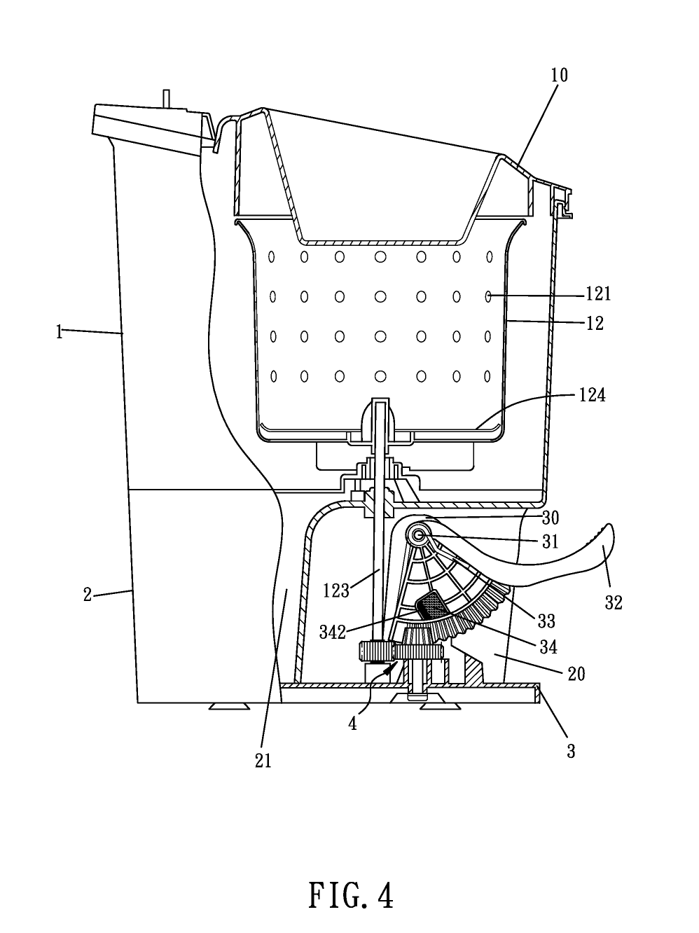

The operation of the washing device and brake mechanism thereof in accordance with the present invention will be described in detailed below. Before washing, the cover (10) is pivotally opened and the dirty clothing items are put into the bucket (12). The cover (10) is pivotally closed and water is poured into the inlet (101) to fill the casing (1). Referring to FIG. 4, the elastomer (33) abuts against the pedal (32) in an initial position. The braking pad (34) disconnects with the spindle (123).

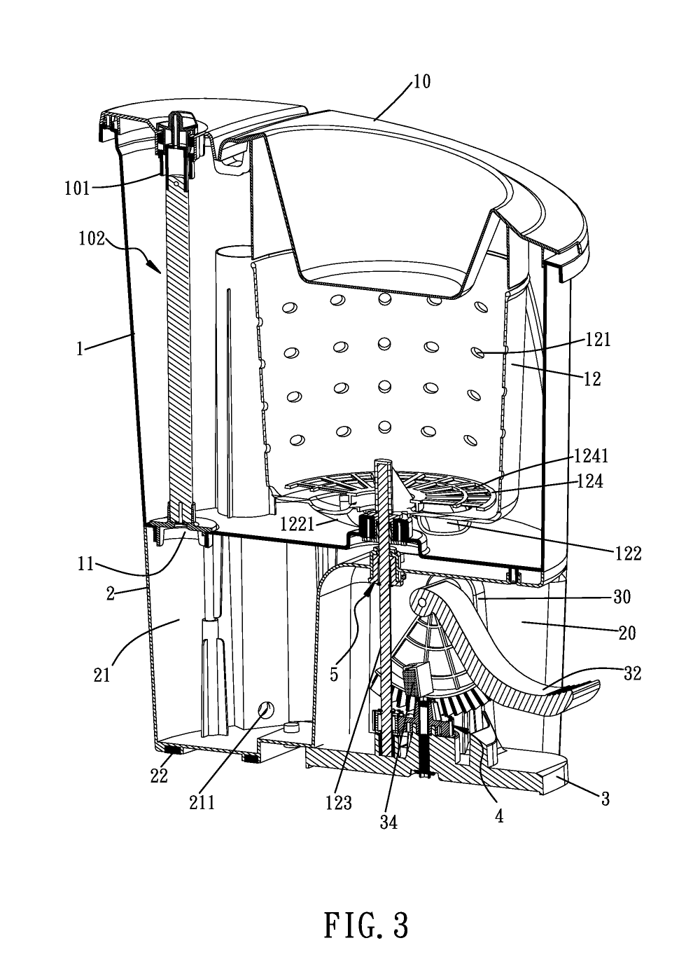

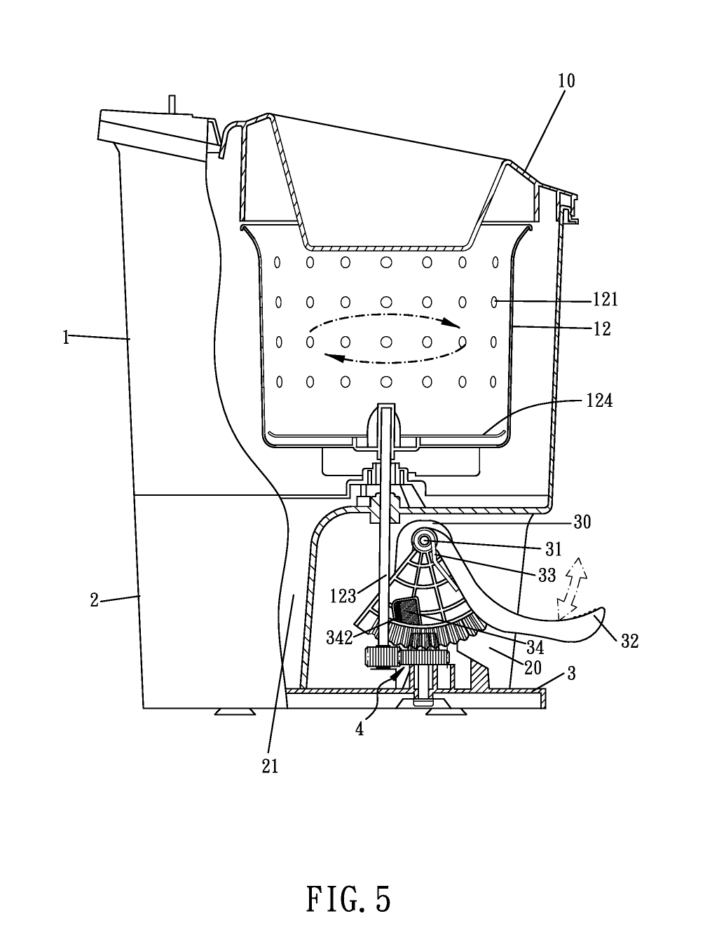

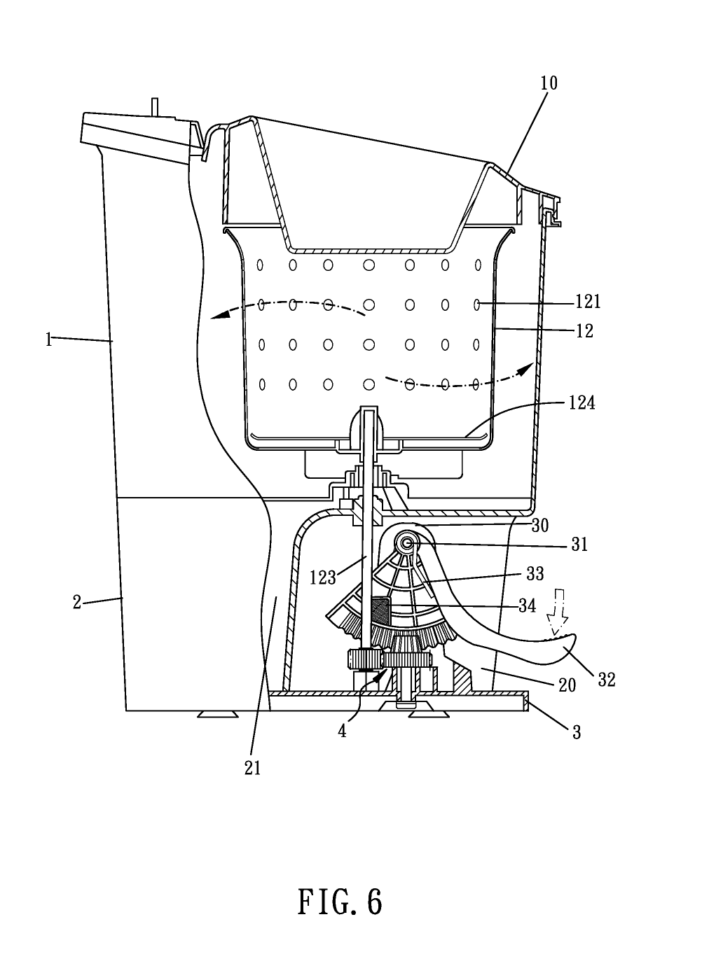

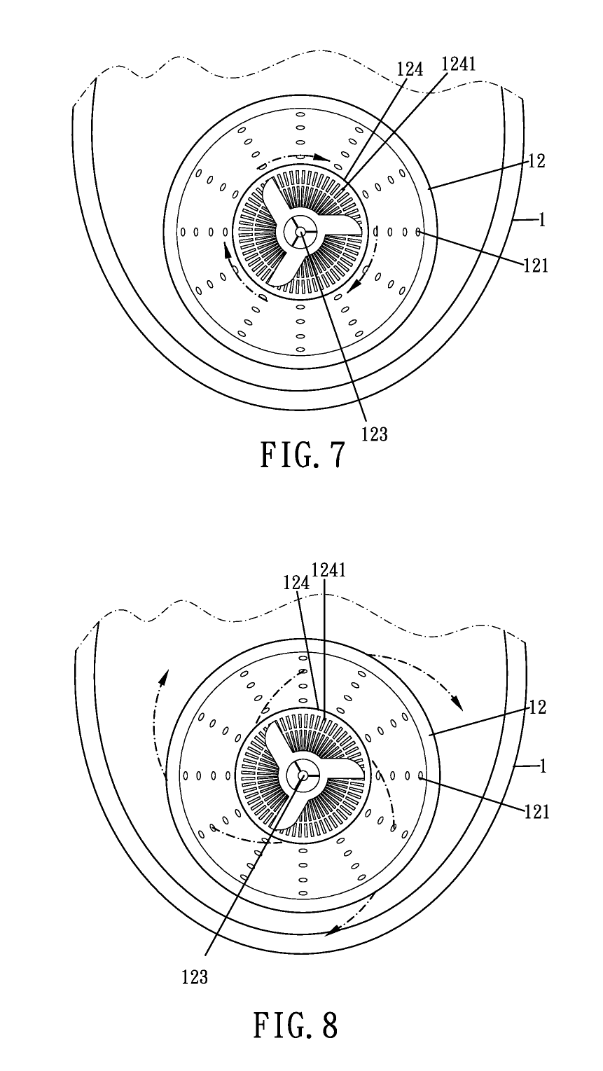

As shown in FIGS. 5-8, when the pedal (32) is treaded to rotate around the rod (31), the end of the pedal (32) which is treaded moves downwardly to drive the gear set (4). The elastomer (33) is compressed by the pedal (32). The spindle (123) is simultaneously driven to pivotally rotate in a direction by the movement of the gear set (4). The bucket (12) is pivotally rotated with the spindle (123) relative to the casing (1). A centrifugal force is generated by a rotation of the bucket (12). Water centrifugally flows away from the bucket (12) via the through holes (121) and is guided into the bucket (12) again via the orifices (122) which are shown in FIG. 3. Therefore, water is swirled in the casing (1) for circulatively washing the clothing items.

When the pedal (32) moves downwardly to a restricted position, the braking pad (34) is moved to connect with the spindle (123). The friction section (342) restricts and abuts against the spindle (123) for stopping the spindle (123) rotating. As the bucket (12) simultaneously stops rotating with the spindle (123), the swirled water in the casing (1) is changed to flow in a reverse direction for enhancing the washing effect.

When the pedal (32) is released, the pedal (32) is moved upwardly to the initial position by the resilient force of the elastomer (33). During the movement of the pedal (32), the spindle (123) is driven to rotate in a reverse direction. The bucket (12) is rotated with the spindle (123) relative to the casing (1) and generates a corresponding centrifugal force. Therefore, the user can reciprocatively operate the braking mechanism (A) for washing the clothing items.

Moreover, when dehydrating the clothing items, the releasing valve (102) is moved to unseal the opening (11). Water in the casing (1) is guided into the storage space (21) of the base (2) via the opening (11). The pedal (32) is reiteratively treaded to actuate the brake mechanism (A). The bucket (12) is rotated relative to the casing (1) to form the centrifugal force for dehydrating water from the clothing items.

Although the invention has been explained in relation to its preferred embodiment, it is to be understood that many other possible modifications and variations can be made without departing from the spirit and scope of the invention as hereinafter claimed.

What is claimed is:

1. A brake mechanism comprising:
a base, the base having a receiving space defined therein;
a spindle and a gear set movably received in the receiving space, the gear set connected with the spindle for simultaneously driving the spindle;
a seat received in the receiving space of the base, the seat having two support portions oppositely formed thereon and extending upwardly therefrom, a rod pivotally connected with the two support portions of the seat;
a pedal pivotally connected with the rod and located between the two support portions of the seat, the pedal movably engaging with the gear set, such that the spindle is simultaneously rotated via the gear set by a movement of the pedal, the pedal having a braking pad disposed on one side thereof and corresponding to the spindle for selectively abutting against the spindle; and
an elastomer pivotally connected with the rod and located adjacent to the pedal for providing a resilient force to the pedal;
whereby when the pedal is operated, the spindle is pivotally rotated by the movement of the pedal; when the braking pad is simultaneously driven by the pedal, the spindle is abutted against by the braking pad and stops rotating.

2. The brake mechanism as claimed in claim 1, wherein the braking pad has a cutout defined therein, the cutout having a friction section formed on an interior surface thereof for selectively rubbing against the spindle.

3. The brake mechanism as claimed in claim 1, wherein the base has a storage space defined therein and located adjacent to the receiving space for storing water, the base having an outlet defined in the storage space for draining water from the storage space.

4. The brake mechanism as claimed in claim 1, wherein the base has a skid-proof mat mounted on a bottom thereof.

5. The brake mechanism as claimed in claim 1 further comprising a reducer movably mounted on the spindle for decreasing a rotating speed and increasing a driving power.

6. A washing device incorporating a brake mechanism as claimed in claim 1, comprising:
a casing having a cover openably mounted thereon for selectively sealing the casing, the cover having an inlet defined therein, such that water flows into the casing via the inlet;
a bucket movably received in the casing, the bucket having a plurality of through holes defined in a lateral thereof and extending therethrough for allowing water passing through the through holes, the bucket having a plurality of orifices defined in a bottom thereof and extending therethrough for allowing water passing through the orifices; and
a brake mechanism connected with the casing and comprising:
a base mounted on a bottom of the casing, the base having a receiving space defined therein;
a spindle pivotally connected with the bucket and partially received in the receiving space for simultaneously driving the bucket to rotate, a gear set movably received in the receiving space and connected with the spindle for simultaneously moving with the spindle;
a seat received in the receiving space of the base, the seat having two support portions oppositely formed thereon and extending upwardly therefrom, a rod pivotally connected with the two support portions of the seat;
a pedal pivotally connected with the rod and located between the two support portions of the seat, the pedal movably connected with the gear set, such that the spindle is simultaneously rotated via the gear set by a movement of the pedal, the pedal having a braking pad disposed on one side thereof and corresponding to the spindle for selectively abutting against the spindle; and
an elasomer pivotally connected with the rod and located adjacent to the pedal for providing a resilient force to the pedal;
whereby when the pedal is operated, the spindle is pivotally rotated by the movement of the pedal and the bucket is rotated relative to the casing by a rotation of the spindle for providing a centrifugal force to adapt to wash clothing items; when the braking pad is simultaneously driven by the pedal, the spindle is abutted against by the braking pad and stops rotating.

7. The washing device as claimed in claim 6, wherein the casing has an opening defined in the bottom thereof and extending therethrough, a releasing valve received in the casing and connected with the cover, the releasing valve selectively sealing the opening for controlling the drainage of the casing;
the bucket having a plurality of turbulent surfaces inclinedly formed on the bottom thereof and respectively disposed adjacent to the orifices for increasing a swirling power during the bucket is rotated, a washing plate rotatably received in the bucket and coaxially sleeving on the spindle, the washing plate having a plurality of grooves radially defined therein and extending therethrough for allowing water passing through the grooves;
the base having a skid-proof mat mounted on a bottom thereof, the base having a storage space defined therein and located adjacent to the receiving space for storing water flowing from the casing, the base having an outlet defined in the storage space for draining water from the storage space;
the brake mechanism including a reducer movably mounted on the spindle for decreasing a rotating speed and increasing a driving power.

8. The washing device as claimed in claim 6, wherein the braking pad has a cutout defined therein, the cutout having a friction section formed on an interior surface thereof for selectively rubbing against the spindle.
